(19) United States
(12) Patent Application Publication
(10) Pub. No.: US 2024/0176946 A1
(43) Pub. Date: May 30, 2024

(54) METHOD OF PUBLISHING A COMPUTER FILE INCLUDING INTERACTIVE DATA AND A METHOD OF MANAGING SAID DATA

(71) Applicants: Radoslav P Kotorov, Somerset, NJ (US); William J Forde, Syosset, NY (US)

(72) Inventors: Radoslav P Kotorov, Somerset, NJ (US); William J Forde, Syosset, NY (US)

(21) Appl. No.: 17/993,959

(22) Filed: Nov. 24, 2022

(51) Int. Cl. G06F 40/106; G06F 3/0485; G06F 40/154; G06F 40/177

(52) U.S. Cl. CPC G06F 40/106; G06F 3/0485; G06F 40/154; G06F 40/177

(57) ABSTRACT

The present invention relates to the field of digital computing and data processing methods. Described are: a method of publishing, on a user computer, a freestanding pageless browser readable computer file including interactive data in the form of text, numeric or image data, and a method of enabling a user to manage, on a user computer, interactive data in the form of text, numeric or image data. A browser readable file is generated on a user computer; an analytic/interactive software engine and interactive data are transferred to said file, and a computer program comprised in said engine is executed for manipulating said interactive data.

### BACKGROUND OF THE INVENTION

The present invention relates to the field of digital computing and data processing methods, in particular, to a method of publishing, on a user computer, a freestanding pageless browser readable computer file including interactive data in the form of text, numeric or image data, and to a method of enabling a user to manage, on a user computer, interactive data in the form of text, numeric or image data.

The methods commonly disclosed in this field usually rely on the search engines designed for searching unstructured data, the latter being structured and otherwise gathered and manipulated during post-search data management stage. Today a number of Internet search engines exist, like Google©, allowing the users to conduct a search by inputting a word or a set of keywords and then submitting the query in a specific language.

Modern search engines allow searching for data of a specific type (e.g. in a text form, text+image presentations, images/videos only, maps etc.), which is indexed accordingly by the search engine itself. The search experience and the accuracy of results remain a top priority for development of the engines, and while modern search engines allow for an accurate search, the results of the query remain in need of processing.

The relevant methods in this field are generally directed at obtaining the query data as the starting point of the data collection and management process. In this way, the query is performed and obtained data is gathered into one document for further structuring. Structuring data provides the advantage being that structured information has the property that the information is all of the same type and the information can be identified by tags or field names. The objective then is to provide structured records of the query data where each data piece is assigned a fieldname and value, making it easier for the user to perceive query data, which is structured, and may be further manipulated to be shown in a particular way.

In general, the state of this field of art reveals a number of drawbacks which have not been properly addressed yet.

1. Currently available methods rely on the query data as such and comprise a necessary search step. Carrying out this step is time-consuming; additionally, it implies that the only data type being processed is query data, rendering said methods ineffective at manipulating data that does not come from a query.

2. Closely connected with the previous drawback, methods including search step necessitate passing the data over a network, meaning that there is a need for constant connection to the Internet, which constitutes a major drawback, especially when the connection breaks while performing Internet-related steps of the existing methods.

3. The data managed is usually provided in a purely static form, meaning that regardless of whether it is query result data or whether the data comes from another source, there is very little room available for manipulating this data. Existing solutions disclose parts of the document being interactive, while in most cases the methods in the field are not configured to provide interactive data or render static data to become interactive.

4. The information layout is usually unresponsive and not intuitive for the end user. The first attempts at structuring the data have constituted sequential listings which, in case of a need to manage huge data volumes, such as inventory lists, required human and time resources to process. Latest solutions make it possible to structure the data in the table format with simple headlines being “Fieldname” and “Value”. Lately, it has become possible to manipulate tabular data, however, pixel perfect layout has not been achieved or mentioned in any of the documents on the topic. The problem of each user having specific varying tastes has initially been solved by providing data in a document without a predetermined final format which then might have been dynamically formatted. However, this solution implies on-the-go formatting which slows other processes and in some cases contradicts the intention of a publisher to retain the initial formatting of the document as published. Another solution in the art is to provide a document viewed in a predetermined way over a number of devices each having different resolutions; additionally, this document may be downloaded from the Internet with a predetermined format. However, this approach typically involves, firstly, the necessity of having Internet connection (like in drawback (2)), and secondly, such documents are typically page-based.

5. The current state of the art does not provide means for protecting interactive data on permission basis, e.g. by securing interactive data with a password, or by providing a possibility of displaying personalized interactive data to a user on the basis of a submitted key.

U.S. Pat. No. 8,983,894 B2 may be considered the closest analogue. This document relates to a method for searching an index of structured and unstructured incoming data received from remote locations on a wide area network or global network, e.g. the Internet or an enterprise intranet, and solves some of the prior art problems by providing a method for revealing the hits returned by a search that are most relevant to the user. Disclosed in U.S. Pat. No. 8,983,894 B2 are a method of producing, on a user computer, a browser readable computer file including a dynamic report presenting the results of a query transmitted over a network to a structured database, said structured database having a plurality of data; and a method of enabling a user to manage, on a user computer, a dynamic report of the contents of an answer set of records received over a network by querying a database for matches between a search criterion and a key word search index of a population of records, after being disconnected from said network. The advantage of this technical solution is that the user is only connected to the network during the search, and processing the data happens after “disconnecting a user computer from a network”. Additionally, an engine is provided being an analytic/interactive engine, which executes a computer program for manipulating data comprising the results of a query.

However, this document does not disclose publishing a file, with “publishing” being a much broader category than “reporting”, or managing and processing interactive data where the result is a freestanding pageless browser readable computer file including interactive data in the form of text, numeric or image data which is comprised entirely of interactive data. Additionally, the pixel perfect layout is neither mentioned nor disclosed, and the problem of achieving fully interactive data remains unaddressed.

U.S. Pat. No. 5,634,064 relates to the creation, distribution and display of electronic documents and more particularly to the viewing of electronic documents. The technical solution in U.S. Pat. No. 5,634,064 permits an article of an electronic document to be read in content flow order allowing the reader to follow the article in a convenient fashion. What is disclosed is an electronic document viewer comprising a digital computer system, an electronic document, mode means for determining one of a plurality of view modes, normal view means and article view means. Other aspects disclosed are a method for viewing electronic documents on a digital computer; an electronic document system and a reader for displaying an electronic document having a predetermined format. The technical solution in U.S. Pat. No. 5,634,064 achieves an advantage being that an electronic document can be viewed with the appearance of the originally created document, and thus addresses the above-mentioned prior art problem (4).

At the same time, this document does not disclose publishing a freestanding pageless browser readable computer file including interactive data in the form of text, numeric or image data. Further, interactivity of data and means allowing the same are not mentioned, and overall the disclosed method does not involve manipulating data in any way, since the document format is predetermined (and it does not constitute a pixel perfect layout). The aim of U.S. Pat. No. 5,634,064 is not to publish a file comprising interactive data and manipulate said data, but rather to provide convenient reading experience for an already created file having predetermined format, wherein the text may be zoomed in or out according to the selected viewing mode.

Document U.S. Pat. No. 5,737,599 B2 relates to the storage and retrieval of data for a computer system, and more particularly to a method and apparatus for optimizing page-based data documents for fast retrieval over networks, and to a method and apparatus for accessing such optimized documents and processing and display of electronic documents. The object of U.S. Pat. No. 5,737,599 B2 is to provide a method and apparatus for optimized page-based documents and downloading desired pages without causing an excessive delay before displaying a page, or portions of a page, to the user.

Disclosed in U.S. Pat. No. 5,737,599 B2 are a method for downloading a multi-page electronic document comprising page offset information hints being optional information added to the document to optimize operations; a method for downloading a document including a plurality of pages from a remote host computer; a computer readable storage medium including program instructions for performing steps during a downloading process for interleaving page contents of a page of a document with a shared object referenced by the page; an apparatus for downloading a page-based document stored on a host; and an apparatus comprising a computer-readable storage medium embodying computer program instructions. In a similar fashion, document U.S. Pat. No. 5,781,785 provides a method and an apparatus for optimizing page-based data documents for fast retrieval over networks and for accessing such optimized documents, while document U.S. Pat. No. 5,819,301 discloses similar methods and apparatus for reading multi-page electronic documents with the aim of eliminating any time delays caused by processing said documents.

However, U.S. Pat. Nos. 5,737,599 B2, 5,819,301 and 5,781,785 do not solve the problem of providing pixel-perfect layout and do not disclose publishing a pageless document with interactive data, since the only type of control over the document provided is related, like in U.S. Pat. No. 5,634,064, to the layout of the document. The only manipulation mentioned in said documents relates to the images, and no manipulation techniques have been implemented or disclosed. Additionally, since the document is retrieved over a network, a strong connection is a must. Finally, the most severe drawback of these documents consists in the file format being predetermined as .pdf format, which deprives the user of a possibility to process data coming from different file types.

Document U.S. Pat. No. 5,860,074 relates to the storage and retrieval of data for a computer system, and more particularly to a method and apparatus for optimizing page-based data documents for fast retrieval over networks, and to a method and apparatus for accessing such optimized documents, as well as for processing and display of electronic documents when retrieved over networks. Said document discloses a method for displaying on a display device of a computer an electronic document having an object and text specified to appear drawn over the object; a method for downloading to a computer and displaying on a display device of the computer an electronic document having a bitmap image and text specified to appear drawn over the image; an apparatus comprising a computer-readable storage medium embodying computer program instructions for displaying on a display device of a computer an electronic document having an object and text specified to appear drawn over the object; and an apparatus comprising a computer-readable storage medium embodying computer program instructions for downloading to a computer and displaying on a display device of the computer an electronic document having a bitmap image and text specified to appear drawn over the object.

U.S. Pat. No. 5,860,074 suffers from the same drawbacks as discussed above and does not provide solutions to the problems discussed in the present disclosure. Even considering that a part of the document is subject to the simplest manipulations, this is not sufficient to state persuasively that the data in electronic documents discussed in U.S. Pat. No. 5,860,074 is interactive.

Document U.S. Pat. No. 6,028,583 relates to graphical image manipulation systems, and more particularly to a method for compositing multiple graphical images. U.S. Pat. No. 6,028,583 discloses a method of compositing a set of ordered image layers, and a computer program tangibly stored on a computer-readable medium for compositing a set of ordered image layers.

In general, U.S. Pat. No. 6,028,583 aims at overcoming a problem where a user, upon manipulating an image in a specific program, may wish to apply a number of effects to multiple layers of one image. Despite disclosing actual manipulation of interactive image data, the technical solution in U.S. Pat. No. 6,028,583 is not related to publishing a file comprising interactive data which may come from a number of sources and types, and manipulating data in U.S. Pat. No. 6,028,583 requires the use of a specific computer program.

Document U.S. Pat. No. 6,289,364 B1 relates to processing and displaying digital documents and to processing images in a raster image processor using transparency information. This document is aimed at providing means to allow blending operations to be performed within a raster image processor to blend an image object in a document. The advantages of described technical solution are, inter alia, conservation of computer resources by performing graphic object blending operations as part of the raster image processing process; allowing graphical objects to remain independent until final output is generated.

Disclosed in U.S. Pat. No. 6,289,364 B1 are a page description language data structure able to be stored in memory and part of a page description language file defining a page description of an image; a program storage device readable by a computer system, the program storage device having encoded therein a program of instructions that includes a page description language file; and a raster image processor comprising an interpreter and a renderer.

Like U.S. Pat. No. 6,028,583, this document is aimed at providing a possibility of interacting with graphical objects in an image allowing applying blending operations to said image; however, the final image layout is not disclosed to be pixel perfect, and the renderer is limited to perform specifically blending operations.

Document U.S. Pat. No. 6,421,460 B1 relates to compositing or blending of graphical image data and in general seems to disclose similar methods and operations as U.S. Pat. No. 6,289,364 B1, but with more blending operations, allowing manipulating the colors. Still, the technical solution disclosed therein is not aimed at publishing a document with interactive data, but rather at manipulating graphic elements in accordance with a transfer mode.

The present disclosure aims at overcoming the described prior art drawbacks consisting in limiting modern methods with specific type of data being processed, said data typically coming from a query, said methods requiring Internet connection to transfer files where the data is typically not fully interactive. Additionally, the present disclosure aims at overcoming the problem of providing a pixel perfect layout to the user, eliminating inconveniences when browsing the interactive data, as well as providing a possibility to protect data on permission basis, e.g. with a key in form of password, or at using said key to provide personalized experience to the user.

### SUMMARY OF THE INVENTION

The present invention overcomes the aforementioned prior art problems in providing a method of publishing, on a user computer, a freestanding pageless browser readable computer file including interactive data in the form of text, numeric or image data, as well as a method of enabling a user to manage, on a user computer, interactive data in the form of text, numeric or image data.

According to the first aspect, the method of the present invention is a method of publishing, on a user computer, a freestanding pageless browser readable computer file including interactive data in the form of text, numeric or image data, the method comprising:
generating on a computer a freestanding pageless browser readable computer file containing no other computer files for receiving said interactive data,
transferring to said freestanding pageless browser readable computer file an analytic/interactive software engine for rendering said freestanding pageless browser readable computer file and for processing the interactivity on said freestanding pageless browser readable computer file, the engine comprising a computer program executable in a browser on any computer on which the browser is operable,
transferring data to said freestanding pageless browser readable computer file, wherein said data and said software engine reside in the same file, saving said freestanding pageless browser readable computer file on said user computer,
executing said computer program provided in said engine on said user computer for manipulating said data, wherein said manipulating comprises one or more of the following:
performing a calculation on the data in one view the result of which is displayed in another view,
performing a calculation on the data in one view the result of which is displayed in another view as a sum of data displayed in said one view,
pivoting said data in the rows and columns of a table displayed in one view for display in another view,
filtering the data displayed in one view for display in another view of a subset of the data in said one view, rolling up the data displayed in one view for display in another view of a subset of the rows of data in said one view,
nesting a subarray of the data displayed in one view in the display of data in another view, and/or
providing a control in one view which when actuated presents the data as scrolling in another view,
when said data is images, swapping images or text associated with images,
when said data is text, creating navigational threads, dynamically changing the same and swapping the text in a limited space based on the user navigation,
wherein said engine is configured to render said file in a pixel perfect format adjusted for any display size, and
wherein interactivity of data comprises analytical interactions for operating on data and navigational interactions operating on display of data.

Such method overcomes the problems of publishing a file which is a freestanding pageless browser readable computer file including interactive data in various forms. This document comprises interactive data for further processing and manipulation, said data being comfortable to browse and change by the user. The method also involves the use of analytic/software engine for rendering the file and processing interactivity by executing a computer program in the engine for providing analytical and navigational interactions. Additionally, the method does not involve an Internet connection and is fully executable in offline mode. The data comes in a variety of types, such as images, text or numeric data. For data layout a pixel perfect format is provided, adjusting the file for any display size.

In one aspect, the data in the method is displayed on a permission, wherein said permission is obtained if a password is submitted. The permission-based access to interactive data serves the purpose of protecting the data from undesirable access, while also providing a solution to personalizing the file in a way.

In another aspect, the data displayed is dynamically personalized at generation time for different users based on a key or password submitted. Personalization of the data on permission basis by inputting a password or a key allows for comfortable user experience, as well as constitutes a convenient tool for managing data by several users. In another aspect, the interactive data is results of a query transmitted over a network to a structured database in the form of an interactive dynamic report, said structured database having a plurality of data.

In another aspect, the interactive data is any data in the form of text, image or database, not related to the results of a query.

In another aspect, said interactive data is acquired from a number of sources, said sources being API, URLs, CSV, Excel, Json, Word and image file formats.

The above-mentioned aspects relating to source of data disclose the possibilities of the claimed method to obtain data in all modern formats as well as in several most common types, such as text, image or database, including numeric data. Since the claimed method does not rely on query results, the commitment to including a search step with the necessity of providing search results analysis is omitted and the method is simplified and made more cost-efficient.

In another aspect, said engine is an interactive Java Script engine.

In another aspect, said manipulating further sorts the data in one view for display in another view.

In yet another aspect, where the interactive data is results of a query transmitted over a network to a structured database in the form of an interactive dynamic report, said structured database having a plurality of data, the claimed method further comprises transferring to said file, over said network, a style sheet, and said manipulating formats the data displayed in one view for display in another view in a font, style or color different from the font, style or color in which said data is displayed in said one view.

In another aspect, the claimed method further comprises providing a control in one view which when actuated exports the entire data or a filtered subset thereof to another file.

In another aspect, the claimed method further comprises providing a control in one view which when actuated emails a copy of said file to another user.

In another aspect, the claimed method further comprises providing a control in one view which when actuated exports a copy of said file to an external computer program.

According to the second aspect, a method of the present invention is a method of enabling a user to manage, on a user computer, interactive data in the form of text, numeric or image data, the method comprising:
modifying interactive data with metadata comprising the name of a tag and at least one value of said tag, each said name of a tag and each said corresponding value forming a tag-value pair, whereby said name of a tag and said at least one value of said tag are added to and made part of the content of said data,
generating on a server computer, to which said user computer is connected over the network, a freestanding pageless computer readable file, containing no other computer files, which can be displayed in a browser, said file comprising interactive data, and an analytic/interactive engine for rendering said freestanding pageless browser readable computer file and for processing the interactivity on said freestanding pageless browser readable computer file, the engine comprising a computer program executable for manipulating said data while disconnected from said network without need for any application external to said analytic/interactive engine other than said browser, wherein said manipulating comprises one or more of the following,
performing a calculation on the data in one view the result of which is displayed in another view,
performing a calculation on the data in one view the result of which is displayed in another view as a sum of data displayed in said one view,
pivoting said data comprising said results of said query in the rows and columns of a table displayed in one view for display in another view,
filtering the data displayed in one view for display in another view of a subset of the data in said one view,
rolling up the data displayed in one view for display in another view of a subset of the rows of data in said one view,
nesting a subarray of the data displayed in one view in the display of data in another view, and/or
providing a control in one view which when actuated presents the data as scrolling in another view,
saving said freestanding pageless computer readable file on said user computer,
when said data is images, swapping images or text associated with images,
when said data is text, creating navigational threads, dynamically changing the same and swapping the text in a limited space based on the user navigation,
wherein said engine is configured to render said file in a pixel perfect format adjusted for any display size, and
wherein interactivity of data comprises analytical interactions for operating on data and navigational interactions operating on display of data.

Such method allows for manipulating interactive data included in the described file with a number of operations providing the user complete control over data and allowing analytical and navigational operations. In this method the computer is connected over the network through which interactive data is transferred, and in the course of performing the steps of the claimed method, the computer is disconnected from the network with need for any external application.

In another aspect, the data is displayed based on a permission, wherein said permission is obtained if a password is submitted.

In yet another aspect, the data displayed is dynamically personalized at generation time for different users based on a key or password submitted.

In the context of said method, the permission system allows the user to only control and manipulate a portion of data available to the user after providing a key or a password. This disclosure makes it possible for the interactive data to be manipulated by several users at a time, each user only manipulating a portion of the data. Alternatively, it is possible to only allow other users to manipulate a portion of the data, with other portion remaining as intended by the publisher.

In another aspect, the interactive data is results of a query transmitted over a network to a structured database in the form of an interactive dynamic report, said structured database having a plurality of data.

In another aspect, the interactive data is any data in the form of text, image or database, not related to the results of a query.

In another aspect, said interactive data is acquired from a number of sources, said sources being API, URLs, CSV, Excel, Json, Word and image file formats.

In another aspect, said engine is an interactive Java Script engine.

In another aspect, the claimed method further comprises executing instructions in said analytic/interactive engine on said data for rendering one view of said tag-value pairs in a table with the tags shown as field names in said table and a value for each tag listed in a cell within said table, and displaying at least one control actuable by a user for transforming the display of said data into another view.

### DESCRIPTION OF THE DRAWINGS

FIG. 1 is a schematic block diagram showing a method of publishing, on a user computer, a freestanding pageless browser readable computer file including interactive data in the form of text, numeric or image data.

FIG. 2 is a schematic block diagram showing previously disclosed method where the data is displayed on the permission basis.

FIG. 3 is a schematic block diagram showing embodiments of the claimed method where additional steps are included.

FIG. 4 is a schematic block diagram showing a method of enabling a user to manage, on a user computer, interactive data in the form of text, numeric or image data.

FIG. 5 is a schematic block diagram showing previously disclosed method of the claimed invention where the data is displayed on the permission basis.

FIG. 6 is a schematic block diagram showing an embodiment of the claimed method where an additional step is included.

### DETAILED DESCRIPTION

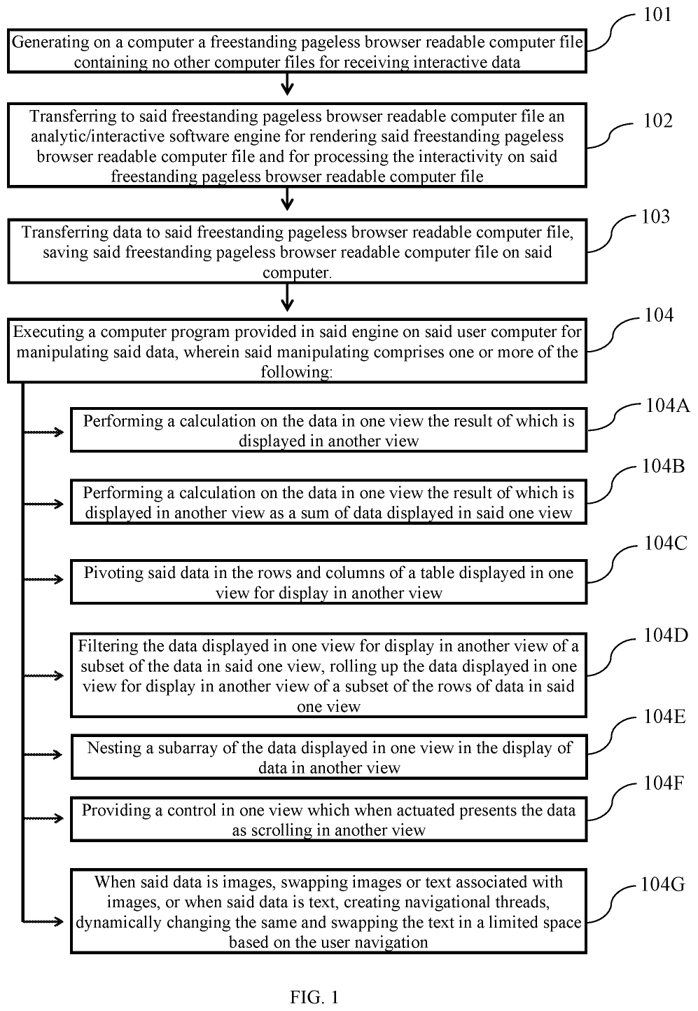

Referring now to FIG. 1 of the drawings there is illustrated a method of publishing, on a user computer, a freestanding pageless browser readable computer file including interactive data in the form of text, numeric or image data.

On step 101 a freestanding pageless browser readable computer file containing no other computer files for receiving interactive data is generated. Generating a file involves a process where a file with a predetermined format is created on the user computer. Prior to generating, a simple check is executed, where what is checked is whether the computer drive has enough space for said file to be generated. If the drive comprises enough space, a file is generated. This file is freestanding, i.e. it is not dependent on other files and does not require any module to be loaded.

Further, the file is pageless, i.e. the whole set of interactive data is presented in the file which does not involve distribution of data pieces over pages. As such, pageless documents do not require the calculation of page space and corresponding data allocation, and instead provide a borderless working surface for browsing and manipulating the interactive data.

The file is further readable in a browser. This is advantageous, since it is implied that not only the file is possible to view via normal “offline” means, but also the file may be opened and manipulated via any web browser program, providing flexibility in accessing the file and working with the interactive data.

On step 102 an analytic/interactive software engine is transferred to said freestanding pageless browser readable computer file for rendering said freestanding pageless browser readable computer file and for processing the interactivity on said freestanding pageless browser readable computer file, the engine comprising a computer program executable in a browser on any computer on which the browser is operable.

In other words, on this step the analytic/software engine is transferred to the previously generated empty computer file. The interactive engine can be written in Java Script® or any similar Internet web programming language, and controls the manipulation and display of the data in the browser and is used for processing the interactivity of the data in the file. This engine processes any data manipulations within the file and renders said file, thus being crucial to the claimed method, and serves as a processor. Additionally, said engine is used to save the interactions of a user with the data.

The engine is further characterized by that it comprises a computer program executable in a browser on any computer on which the browser is operable. Said computer program comprises a set of instructions for rendering the computer file and manipulating the data. Since the computer file is browser readable and is supposed to be opened and manipulated on any computer to allow access flexibility, the program is also configured to be executable in a browser to ensure the correct opening and processing of the file.

On step 103 the interactive data is transferred to said freestanding pageless browser readable computer file, wherein said data and said software engine reside in the same file, and said freestanding pageless browser readable computer file is then saved on said user computer. Since it would be inconvenient for the user and generally impractical to keep data and the engine for processing said data separately on a user computer, prompting the need to allocate more space and remember the locations of the engine and the data, said engine and said data are stored in the same computer file. To keep the file and to ensure that it is not lost after operating thereon, the file is saved on a user computer.

On step 104 the data is manipulated by executing said computer program provided in said engine on said user computer. The program, as was mentioned before, comprises a set of instructions, configured to initiate a data manipulation process based on user input. The data here is manipulated before publishing the file to bring data in the form intended by the user and to produce a desired result. It should be understood that the manipulation processes disclosed herein are not limiting. Said manipulation comprises one or more of the following:

On step 104A, performing a calculation on the data in one view the result of which is displayed in another view. The user may initiate a calculation process on the data and simply change the view of the data being the result of said calculation. This provides flexibility when manipulating the data by allowing the user to present it in a desired way, and also ensures that the data is displayed more efficiently with smart use of the space in a pageless computer file. The initial view may therefore be called “standard view” and is selected automatically when the data is transferred to the file on step 103. The new view does not influence the content of the file, but instead only the data layout is rearranged.

On step 104B, performing a calculation on the data in one view the result of which is displayed in another view as a sum of data displayed in said one view. This manipulation refers, like the one on step 104A, to collecting the data with the aim of presenting it in a summarized way, with a layout different from the “standard view”. This serves the purpose of allowing the data to be structured across the pageless browser readable computer file.

On step 104C, pivoting interactive data in the rows and columns of a table displayed in one view for display in another view. On this step, the data is also structured, but, unlike step 104B, in a tabular way, allowing for comfortable browsing of data divided into types and values regardless of the data type. Pivoting refers to, for instance, displaying product prices by brand and category in order to compare.

On step 104D, filtering the data displayed in one view for display in another view of a subset of the data in said one view, rolling up the data displayed in one view for display in another view of a subset of the rows of data in said one view. This is another way of structuring the data by displaying only a portion thereof called a “subset”, i.e. the portion of data of interest for a specific purpose.

On step 104E, nesting a subarray of the data displayed in one view in the display of data in another view. Building upon the process disclosed in step 104D, this process allows nesting subarrays of the data within the cells of the main array for more complex data structures.

On step 104F, providing a control in one view which when actuated presents the data as scrolling in another view. This process allows the user to control the flow of data being shown, in particular, allowing displaying the interactive data as a continuous stream of data, which, due to the large data quantities, may be incorrectly displayed on one screen. When actuated, the data is presented as scrolling in another view, which essentially allows the user to browse large quantities of data by simply scrolling down the screen to reveal further interactive data pieces.

Finally, on step 104G, when said data is images, swapping images or text associated with images, or, when said data is text, creating navigational threads, dynamically changing the same and swapping the text in a limited space based on the user navigation. It is possible, in the claimed invention, for the data to be in different forms and come from various sources, namely, in the form of images or text. In this case, when the data is images, this step allows for swapping said images or text associated with images. In the event interactive data is presented in text form, it is possible for a user to create navigational threads, modify said threads, and swap the text in a limited space based on the desired navigation. Navigational threads allow the user to browse the desired data among the whole plurality of data, and find the data needed more quickly.

Describing the claimed process in more detail, the analytic/software engine is configured to render said file in a pixel perfect format adjusted for any display size. The obvious advantage of this feature consists in allowing the file to not only be opened on any device as long as the browser is supported, but also to automatically fit any display size regardless of the device the file is viewed in. Pixel perfect format does not relate to data structure, but rather to the visual layout of the document.

It should be also mentioned that in the claimed method interactivity of data comprises analytical interactions for operating on data and navigational interactions operating on display of data. It means that the user-data interactions are of two types, the former refers to browsing and analyzing said data, while the latter refers to display of the data, and visualization thereof. The user is free in the work with interactive data and is not artificially limited in any way except for obvious limitations imposed by the current technology. Thus, the user may find it most comfortable to work with said document which is pageless and in pixel perfect format, and comprises interactive data.

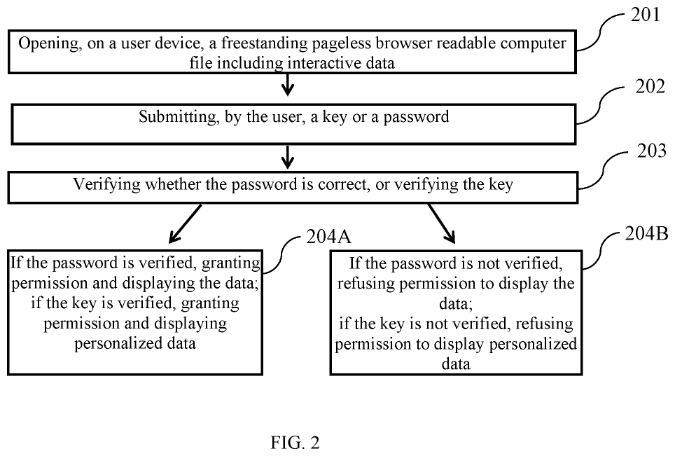

Referring now to FIG. 2 of the drawings there is illustrated an embodiment of the claimed invention incorporating permission-based access to the interactive data in said file. Permission-based access to data has been practiced as a way to keep data secured and only accessible by a limited and controlled number of users. In context of the claimed invention the permission-based access is not limited to security only, but also serves as a tool for enhancing user experience by presenting personalized data. The latter option is particularly useful when the file is to be accessed by a number of users, but this application is not limiting. In one embodiment, the data is displayed on a permission, wherein said permission is obtained if a password is submitted. In this case, the password is a combination of letters, numbers, symbols or any other textual data selected by the user. In another embodiment, the data displayed is dynamically personalized at generation time for different users based on a key or password submitted. It is implied, therefore, that interactivity of said data is limited to the permitted portion. Accessing the data protected by a password or personalized by a key involves the following operations.

On step 201, opening, on a user device, a freestanding pageless browser readable computer file including interactive data. As was discussed before, the file may be opened on any device supporting the required browser program. Opening the file involves any action by the user which prompts the file to be opened.

On step 202, submitting, by the user, a key or a password. The password may be typed or voiced by the user to be received and processed by the user device. The key may be similar to a password being a combination of sounds (when voiced), numbers or text (when type), or constitute an electronic key. The mode of submitting a key or a password by the user can be selected beforehand or comprise several options from which a user chooses the preferable mode of submission.

On step 203, verifying whether the password is correct, or verifying the key. Verification is usually performed by analysis of submitted data and further comparison of the submitted password or key with the correct password or key. In case of submitting a key, the submitted data may be compared with a number of existing keys one after another, or compared with all existing keys simultaneously. The result of verification is determining, whether what is submitted matches with a key or a password, which further prompts specific reaction from the file. Two options are, therefore, as follows.

On step 204A, if the password is verified, granting permission and displaying the data, if the key is verified, granting permission and displaying personalized data. The result of this process prompts a reaction from the file to be opened and the interactive data to be displayed. Additionally, if the key is verified, the document is opened and only the permitted portion of the interactive data is displayed to a user.

On step 204B, if the password is not verified, refusing permission to display the data, or, if the key is not verified, refusing permission to display personalized data. Permission refusal, understandably, results in the data not being displayed, however, certain options are available to enhance the user experience. Usually, upon failing to submit a password or a key which are further verified, the file is closed, which prompts the user to open said file again, wait for it to load, and try again. Instead, it is possible to allow the user to re-submit the password or a key without closing the file. Numerous implementation possibilities are available in the prior art and can be made use of in this instance.

It is also possible, in this particular case, to distinguish access to data and access to interactivity operations on said data, wherein more than one password is needed to grant full control over data to the user. In this case, multiple steps of submitting password and further verification thereof are required, which strengthens the security aspect, but at the same time reduces comfort enjoyed by the user when opening a protected file.

It is further possible, with the aim of negating the above-mentioned drawback of multiple verification steps, or to prevent the user from experiencing delays connected to the need of submitting the same password every time a document is opened in quick succession, to provide the user with the possibility of making the file remember the password for a limited amount of time, so that if the file is accidentally closed and immediately opened, the file would remember the user during a specified period of time.

The data may be results of a query transmitted over a network to a structured database in the form of an interactive dynamic report, said structured database having a plurality of data. For this process (not shown), some steps are required before generating a file. Namely, it is mandatory to provide instructions to the engine to initiate a query and perform a “search step”, the conditions of which (e.g. the keywords) are determined by the user and results thereof are transmitted to a structured database in the form of an interactive dynamic report. Said report comprises a rundown of interactive data disclosing the results of a search and certain headlines or tag-value pairs attached to the query results. In this case, the interactive data to be transmitted to a file later is in the form of a structured database comprising a plurality of data. Therefore, this embodiment builds upon the existing techniques to incorporate publishing a computer file where the data is the results of a query.

At the same time, the data may not constitute the results of a query and instead be provided in the form of text, image or database. It is advantageous, since the claimed invention is therefore not limited by a certain data type, but is able to process a number of interactive data types.

The interactive data may, in general, be acquired from a number of sources, said sources being API, URLs, CSV, Excel, Json, Word and image file formats. The claimed method is thus able to deal with a large number of data types, irrespective of where the data comes from or what is the format of the data source.

The engine may be an interactive Java Script engine. This feature allows the user to interact with the content directly in the computer file, which implies an improvement in the interactivity level of the data provided.

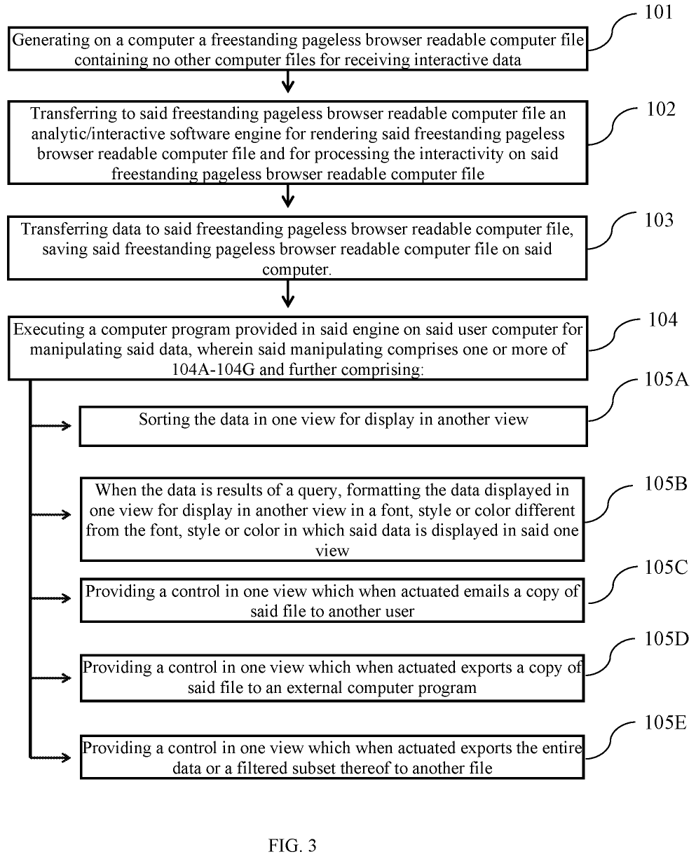

Referring now to FIG. 3 of the drawings there is illustrated the claimed method including additional steps according to the embodiments.

Steps from 101 to 104A-G repeat those steps of the claimed method referred to in FIG. 1 and discussed above. Alternative steps are provided as follows.

On step 105A, sorting the data in one view for display in another view. This process allows for more detailed manipulation of data by the user, involving both display of the data where the first or best place is reserved for the most relevant data, as well as ensuring better and simpler navigation over data. For example, a user may require for the images to be displayed over the text, and the text to be listed below followed by a table. This process makes it possible to sort the data as required by the user. In another example, the user may want certain parts of the data to come first, which is also possible on this step. However, it should be noted that only data pieces sharing a similarity can be sorted in such way. On the other hand, when the data constitutes the results of a query where the data is searched with the keywords, it is possible to clearly identify similar data and sort it in the required way by any of the available categories. The operations included in sorting may be ascending, descending, filter, calculate and the like.

On step 105B, when the data is results of a query, formatting the data displayed in one view for display in another view in a font, style or color different from the font, style or color in which said data is displayed in said one view. This process allows the user to manipulate the data in a stylistic way, assigning certain attributes to specific query results which are of particular interest for the user, said attributes including font, style and color. In one example, it is possible to highlight the desired search results with yellow color, while the irrelevant search results are highlighted in red. In another example, while also implementing the permission access, it is possible to direct a user to manipulate a portion of data highlighted in a certain color or typed with a certain font or style, therefore clearly limiting the manipulation capabilities of a particular user while still displaying the whole data piece.

On step 105C, providing a control in one view which when actuated emails a copy of said file to another user. In this process, a published file comprising interactive data (irrespective of whether the data was manipulated on) is emailed to another user who can receive said file and manipulate the interactive data comprised therein.

On step 105D, providing a control in one view which when actuated exports a copy of said file to an external computer program. Discussed herein is a process for exporting the interactive data manipulated by the user to a specific computer program in a format compatible with the receiving program. An example of this process may be when a user publishes a file including interactive data, manipulates said data in a certain way, and then exports a copy of said file to another program for data analysis or inclusion in a word processing document.

On step 105E, providing a control in one view which when actuated exports the entire data or a filtered subset thereof to another file. In this process it is possible to only export a part of the data called a “subset” which is filtered by the user to another file, or to export the entirety of interactive data to another file with the aim of making a copy, or creating computer files comprising filtered data for further review and publishing.

The advantages of the claimed publishing method have been discussed in detail and would be clear to a person skilled in the art.

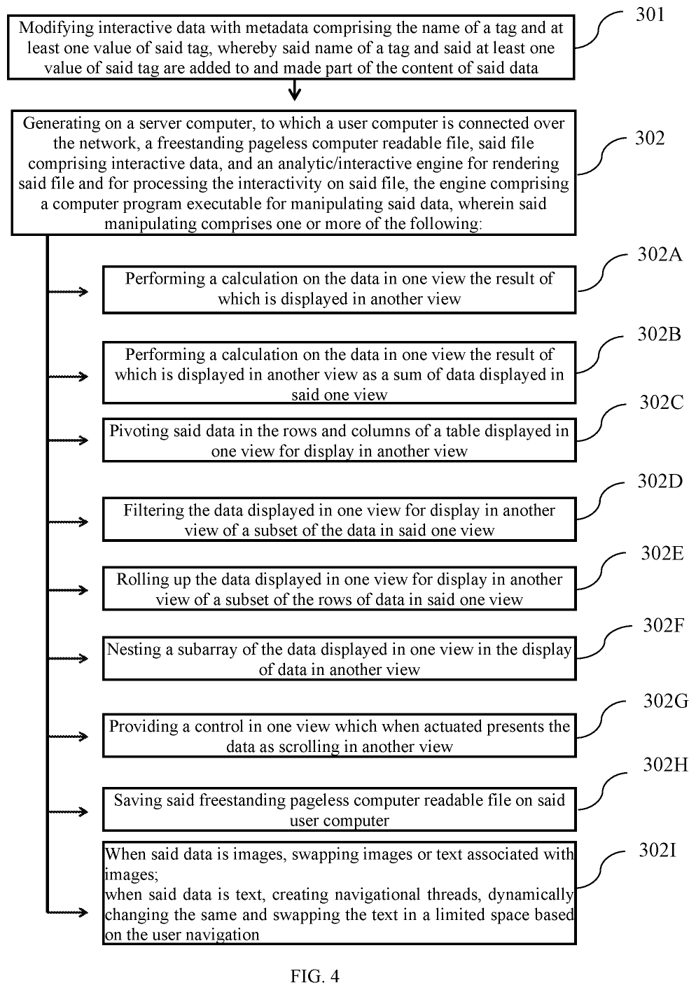

Referring now to FIG. 4 of the drawings there is illustrated a method of enabling a user to manage, on a user computer, interactive data in the form of text, numeric or image data.

On step 301, modifying interactive data with metadata comprising the name of a tag and at least one value of said tag, whereby said name of a tag and said at least one value of said tag are added to and made part of the content of said data. On this step each portion of interactive data is assigned certain metadata constituting a name of a tag and at least one value of said tag. This metadata allows further processing of the data, for example, sorting said data, due to the metadata defining value of a certain portion of data.

On step 302, generating on a server computer, to which a user computer is connected over the network, a freestanding pageless computer readable file, said file comprising interactive data, and an analytic/interactive engine for rendering said file and for processing the interactivity on said file, the engine comprising a computer program executable for manipulating said data. This step is similar to steps 102-104 of the claimed publishing method, disclosed in FIG. 1 and discussed above. Said file is generated, said engine comprising the computer program is transferred to said file and said computer program is executed to manipulate the data. Said manipulating comprises one or more of the following.

Steps 302A-G, 3021 correspond to steps 104A-F, 104G of FIG. 1 of the claimed publishing method respectively. Step 302H corresponds partially to step 103. Said steps have already been discussed in detail above and are sufficiently clear for a person skilled in the art.

The claimed managing method is further characterized by that the analytic/software engine is configured to render said file in a pixel perfect format adjusted for any display size and that in the claimed method interactivity of data comprises analytical interactions for operating on data and navigational interactions operating on display of data. Said features operate here in the same manner as discussed above.

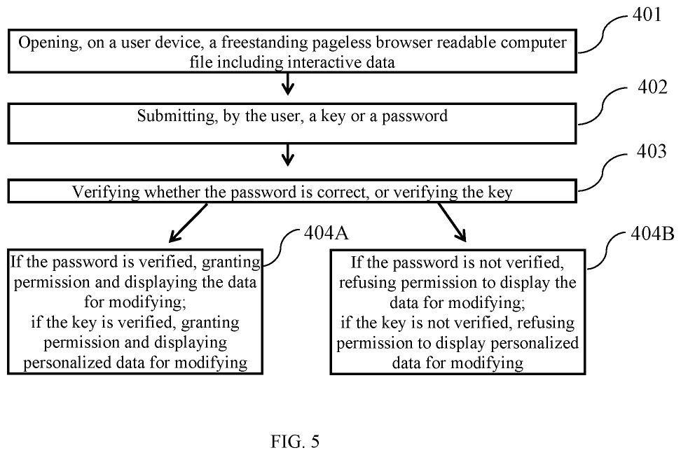

Referring now to FIG. 5 of the drawings there is illustrated an embodiment of the claimed invention incorporating permission-based access to the interactive data in said file. Steps 401-404B here correspond to steps 202-204B of FIG. 2 discussed above.

The claimed method is, similarly to the publishing method discussed above, characterized by the following features: 1) the data may be results of a query transmitted over a network to a structured database in the form of an interactive dynamic report, said structured database having a plurality of data; 2) the data may not constitute the results of a query and instead be provided in the form of text, image or database; 3) the interactive data may be acquired from a number of sources, said sources being API, URLs, CSV, Excel, Json, Word and image file formats; 4) the engine may be an interactive Java Script engine.

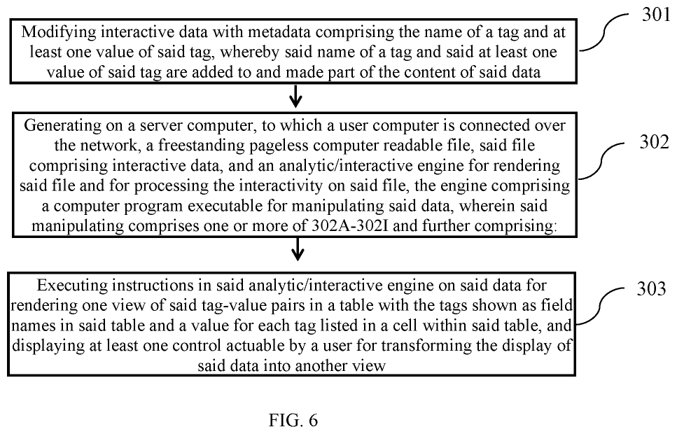

Referring now to FIG. 6 of the drawings there is illustrated the claimed method including an additional step according to the embodiments. Steps from 301 to 302A-I repeat those steps of the claimed method referred to in FIG. 3 and discussed above. Alternative step is provided as follows.

On step 303, executing instructions in said analytic/interactive engine on said data for rendering one view of said tag-value pairs in a table with the tags shown as field names in said table and a value for each tag listed in a cell within said table, and displaying at least one control actuable by a user for transforming the display of said data into another view. Disclosed here is the process of prompting said engine to manipulate interactive data for rendering the interactive data in a table comprising tag-value pairs, and further displaying a control to the user which, when actuated, transforms said tabular interactive data into another view, selected by the user and desirable for particular purposes. It is especially convenient, since usually, due to large degree of freedom when manipulating the data, the user has to spend time reviewing the options before selecting the desirable formatting option. At the same time, with one (or several) control, the user is able to perform basic transformation operations which results in another view, different from the tabular one.

The advantages of the claimed methods have been discussed in detail and would be clear to a person skilled in the art. In particular, the present disclosure overcomes defects of the prior art by transcending limitations regarding specific type of data being processed, said data coming from a number of sources and in various file formats. The claimed invention does not require Internet connection to transfer files and provides a file where the data is fully interactive with a number of options presented to the user to perform manipulation over interactive data. The file can be protected by a password which ensures data security and further advancements in providing personalized data are disclosed. The claimed invention is also able to configure the data to be presented to the user in a pixel perfect format.

Although certain embodiments of the present invention have been described, those skilled in the art will appreciate that various modifications, additions and substitutions are possible without going beyond the scope of the invention which is discussed in the claims.

1. A method of publishing, on a user computer, a freestanding pageless browser readable computer file including interactive data in the form of text, numeric or image data, the method comprising:
generating on a computer a freestanding pageless browser readable computer file containing no other computer files for receiving said interactive data,
transferring to said freestanding pageless browser readable computer file an analytic/interactive software engine for rendering said freestanding pageless browser readable computer file and for processing the interactivity on said freestanding pageless browser readable computer file, the engine comprising a computer program executable in a browser on any computer on which the browser is operable,
transferring data to said freestanding pageless browser readable computer file, wherein said data and said software engine reside in the same file, saving said freestanding pageless browser readable computer file on said user computer,
executing said computer program provided in said engine on said user computer for manipulating said data, wherein said manipulating comprises one or more of the following:
performing a calculation on the data in one view the result of which is displayed in another view,
performing a calculation on the data in one view the result of which is displayed in another view as a sum of data displayed in said one view,
pivoting said data in the rows and columns of a table displayed in one view for display in another view,
filtering the data displayed in one view for display in another view of a subset of the data in said one view, rolling up the data displayed in one view for display in another view of a subset of the rows of data in said one view,
nesting a subarray of the data displayed in one view in the display of data in another view, and/or
providing a control in one view which when actuated presents the data as scrolling in another view,
when said data is images, swapping images or text associated with images,
when said data is text, creating navigational threads, dynamically changing the same and swapping the text in a limited space based on the user navigation,
wherein said engine is configured to render said file in a pixel perfect format adjusted for any display size, and
wherein interactivity of data comprises analytical interactions for operating on data and navigational interactions operating on display of data.

2. The method according to claim 1, wherein the data is displayed based on a permission, wherein said permission is obtained if a password is submitted.

3. The method according to claim 2, wherein the data displayed is dynamically personalized at generation time for different users based on a key or password submitted.

4. The method according to claim 1, wherein the interactive data is results of a query transmitted over a network to a structured database in the form of an interactive dynamic report, said structured database having a plurality of data.

5. The method according to claim 1, wherein the interactive data is any data in the form of text, image or database, not related to the results of a query.

6. The method according to claim 1, wherein said interactive data is acquired from a number of sources, said sources being API, URLs, CSV, Excel, Json, Word and image file formats.

7. The method according to claim 1, wherein said engine is an interactive Java Script engine.

8. The method according to claim 1, wherein said manipulating further sorts the data in one view for display in another view.

9. The method according to claim 4, further comprising transferring to said file, over said network, a style sheet, and said manipulating formats the data displayed in one view for display in another view in a font, style or color different from the font, style or color in which said data is displayed in said one view.

10. The method according to claim 1, further comprising providing a control in one view which when actuated emails a copy of said file to another user.

11. The method according to claim 1, further comprising providing a control in one view which when actuated exports a copy of said file to an external computer program.

12. The method according to claim 1, further comprising providing a control in one view which when actuated exports the entire data or a filtered subset thereof to another file.

13. A method of enabling a user to manage, on a user computer, interactive data in the form of text, numeric or image data, the method comprising:
modifying interactive data with metadata comprising the name of a tag and at least one value of said tag, each said name of a tag and each said corresponding value forming a tag-value pair, whereby said name of a tag and said at least one value of said tag are added to and made part of the content of said data,
generating on a server computer, to which said user computer is connected over the network, a freestanding pageless computer readable file, containing no other computer files, which can be displayed in a browser, said file comprising interactive data, and an analytic/interactive engine for rendering said freestanding pageless browser readable computer file and for processing the interactivity on said freestanding pageless browser readable computer file, the engine comprising a computer program executable for manipulating said data while disconnected from said network without need for any application external to said analytic/interactive engine other than said browser, wherein said manipulating comprises one or more of the following,
performing a calculation on the data in one view the result of which is displayed in another view,
performing a calculation on the data in one view the result of which is displayed in another view as a sum of data displayed in said one view,
pivoting said data comprising said results of said query in the rows and columns of a table displayed in one view for display in another view,
filtering the data displayed in one view for display in another view of a subset of the data in said one view,
rolling up the data displayed in one view for display in another view of a subset of the rows of data in said one view,
nesting a subarray of the data displayed in one view in the display of data in another view, and/or
providing a control in one view which when actuated presents the data as scrolling in another view,
saving said freestanding pageless computer readable file on said user computer,
when said data is images, swapping images or text associated with images,
when said data is text, creating navigational threads, dynamically changing the same and swapping the text in a limited space based on the user navigation,
wherein said engine is configured to render said file in a pixel perfect format adjusted for any display size, and
wherein interactivity of data comprises analytical interactions for operating on data and navigational interactions operating on display of data.

14. The method according to claim 13 wherein the data is displayed based on a permission, wherein said permission is obtained if a password is submitted.

15. The method according to claim 14, wherein the data displayed is dynamically personalized at generation time for different users based on a key or password submitted.

16. The method according to claim 13, wherein the interactive data is results of a query transmitted over a network to a structured database in the form of an interactive dynamic report, said structured database having a plurality of data.

17. The method according to claim 13, wherein the interactive data is any data in the form of text, image or database, not related to the results of a query.

18. The method according to claim 13, wherein said interactive data is acquired from a number of sources, said sources being API, URLs, CSV, Excel, Json, Word and image file formats.

19. The method according to claim 13, wherein said engine is an interactive Java Script engine.

20. The method according to claim 13 further comprising: executing instructions in said analytic/interactive engine on said data for rendering one view of said tag-value pairs in a table with the tags shown as field names in said table and a value for each tag listed in a cell within said table, and displaying at least one control actuable by a user for transforming the display of said data into another view.
